(19) United States
(12) Patent Application Publication
(10) Pub. No.: US 2003/0140458 A1
(43) Pub. Date: Jul. 31, 2003

(54) Handle structure for a container tool

(76) Inventor: Su-Chen Lin, Ta-Li City (TW)

Correspondence Address: Charles E. Baxley, Fifth Floor, 59 John Street, New York, NY, 10038, US

(21) Appl. No.: 10/057,268

(22) Filed: Jan. 28, 2002

(51) Int. Cl. E05B 1/00

(52) U.S. Cl. 16/431

(57) ABSTRACT

A handle structure for a container tool includes a handle having an arched shape to facilitate gripping, and an arched section in the middle thereof, a plurality of positioning blocks integrally projecting from the arched section of the handle, and a non-slip layer wrapping around the arched section such that the outer surfaces of the positioning blocks are exposed from the non-slip layer. The outer surfaces of the positioning blocks are flushed with the outer surface of the non-slip layer therearound. The positioning blocks can position the non-slip layer on the arched section.

### BACKGROUND OF THE INVENTION

(a) Field of the Invention

The present invention relates to a handle structure, more particularly to a handle structure for a container tool.

(b) Description of the Prior Art

FIG. 1 shows a conventional handle, which is integrally formed from a plastic material and which has an arched shape. Two open ends of the handle are provided to hook and connect to a tool box, a container tool, or the like. The arched portion in the middle is adapted for gripping by the user. In actual use, since the user's hand may have oily stains thereon, the handle may slip when the user grips the handle. Referring to FIG. 2, to overcome the drawback associated with the handle of FIG. 1, manufacturers provides a non-slip rubber layer for wrapping around the entire handle of FIG. 1. However, such a product is costly. Besides, it is pointless to wrap the ends of the handle in rubber. FIG. 3 shows a further kind of handle that is aimed to eliminate the drawback associated with the handle of FIG. 2. In this handle, only the arched portion in the middle is wrapped in a non-slip rubber layer so as to reduce rubber material and costs, while maintaining the non-slip effect. However, as the rubber layer is directly sleeved on the handle and is not secured on the handle by any means, after a period of use, the rubber layer may deteriorate due to environmental and temperature factors and may slip from its position.

### SUMMARY OF THE INVENTION

Therefore, the primary object of the invention is to provide a handle structure for a container tool which overcomes the slippage problems associated with the prior art by positioning a rubber non-slip layer on the handle, and which can enhance the appearance of the handle.

Accordingly, the handle structure of the invention includes:

a handle having an arched shape to facilitate gripping and an arched section in the middle thereof;

a plurality of positioning blocks integrally projecting from the arched section of the handle; and

a non-slip layer wrapping around the exterior of the arched section such that outer surfaces of the positioning blocks are exposed from the non-slip layer and are flushed with the outer surface of the non-slip layer therearound.

### BRIEF DESCRIPTION OF THE DRAWINGS

The foregoing and other features and advantages of the present invention will be more clearly understood from the following detailed description and the accompanying drawings, in which,

FIG. 1 is a perspective view of a conventional handle;

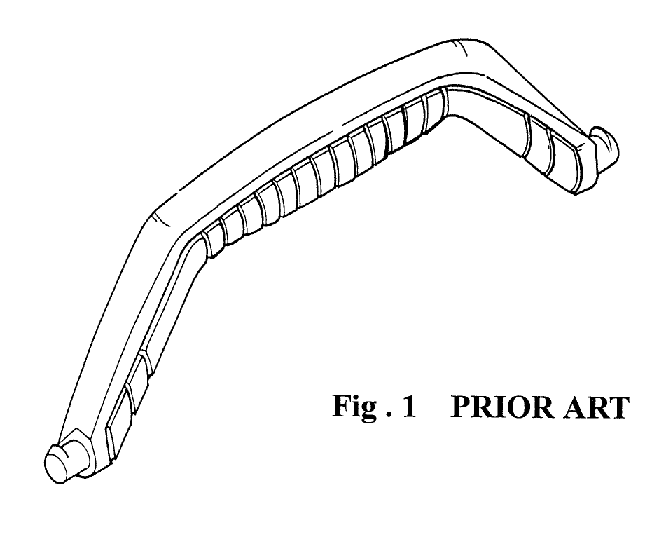

FIG. 2 is a perspective view of a rubber non-slip layer for enveloping the handle of FIG. 1;

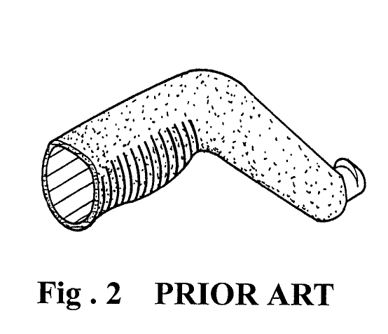

FIG. 3 is a perspective view of another conventional handle;

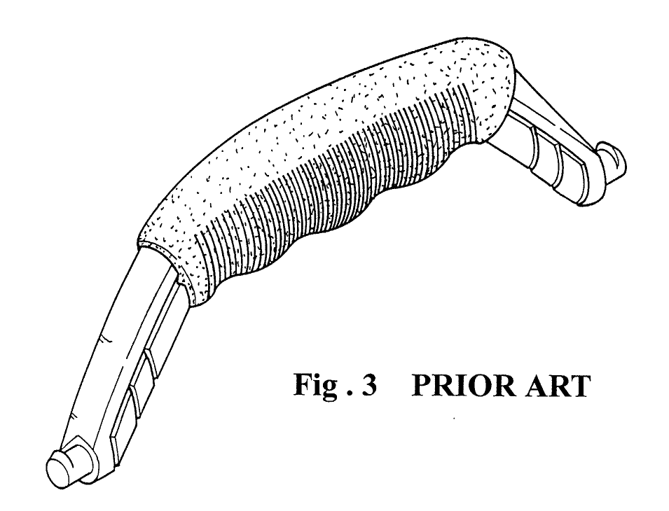

FIG. 4 is a perspective view of the handle of the present invention; and

FIG. 5 is a sectional view taken along line 5-5 of FIG. 4.

### DETAILED DESCRIPTION OF THE PREFERRED EMBODIMENT

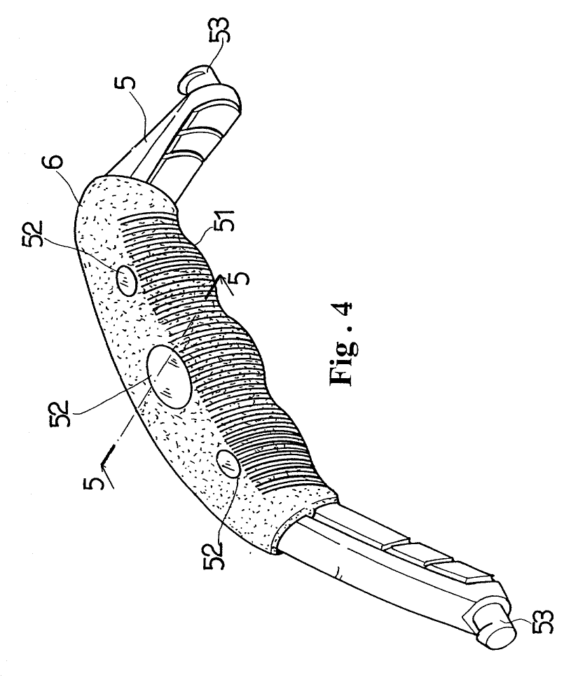

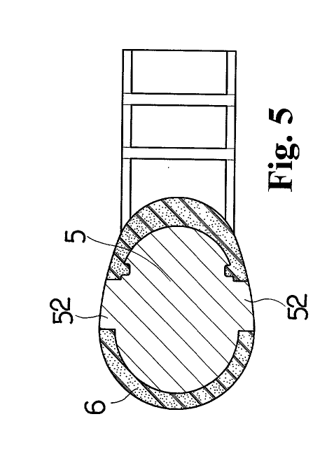

Referring to FIGS. 4 and 5, the present invention includes a handle 5 made of a plastic material and has an arched section 51 adapted for gripping by the user. The handle 5 has two ends each of which is provided with a projecting block 53 for hooking or connecting to a body of a container tool. The handle 5 facilitates the carrying of the container tool. A plurality of positioning blocks 52 integrally project from the arched section 51 in the middle of the handle 5. A non-slip layer 6, which is formed from rubber, wraps the exterior of the arched section 51 such that outer surfaces of the positioning blocks 52 are exposed from the non-slip layer 6. The outer surfaces of the positioning blocks 52 are flushed with the outer surface of the non-slip layer 6 therearound.

By virtue of the positioning blocks 52, the non-slip layer 6 is prevented from slippage and displacement, even when the non-slip layer 6 has become loosened after prolonged use and due to environmental and temperature factors. The positioning blocks 52 prevents slippage of the non-slip layer to provide better stability for gripping of the handle by the user.

The positioning blocks 52 can be configured to have different patterns or trademark devices to enhance appearance of the handle 5.

Although the present invention has been illustrated and described with reference to the preferred embodiment thereof, it should be understood that it is in no way limited to the details of such embodiment but is capable of numerous modifications within the scope of the appended claims.

What is claimed is:

1. A handle structure for a container tool, comprising:
a handle;
a plurality of positioning blocks that integrally project from the surface of said handle; and
a non-slip layer wrapping around the exterior of said handle such that outer surfaces of said positioning blocks is exposed from said non-slip layer.

2. The handle structure for a container tool as claimed in claim 1, wherein said outer surfaces of said positioning blocks can be configured to have different patterns.

3. The handle structure for a container tool as claimed in claim 1, wherein said positioning blocks can have different shapes.

4. The handle structure for a container tool as claimed in claim 1, wherein said handle has an arched shape to facilitate gripping.

5. The handle structure for a container tool as claimed in claim 4, wherein said handle has an arched section in the middle thereof.

6. The handle structure for a container tool as claimed in claim 5, wherein said positioning blocks are provided on said arched section.

7. The handle structure for a container tool as claimed in claim 6, wherein said non-slip layer wraps around said arched section.

8. The handle structure for a container tool as claimed in claim 1, wherein said outer surfaces of said positioning blocks are flushed with the outer surface of said non-slip layer therearound.

9. The handle structure for a container tool as claimed in claim 1, wherein said non-slip layer is formed from a rubber material.
